(19) United States
(12) Patent Application Publication
(10) Pub. No.: US 2005/0062190 A1
(43) Pub. Date: Mar. 24, 2005

(54) Method for manufacturing of comb handle

(76) Inventor: Ki Hong Jang, Seoul (KR)

Correspondence Address: LEVINE & MANDELBAUM, 444 MADISON AVENUE, 35TH FLOOR, NEW YORK, NY, 10022, US

(21) Appl. No.: 10/669,672

(22) Filed: Sep. 24, 2003

(51) Int. Cl. B29C 37/02

(52) U.S. Cl. 264/132; 264/250; 264/138

(57) ABSTRACT

The present invention relates to the method for manufacturing of comb-handle, more particularly to the method capable of manufacturing the comb-handle that its appearance is very beautiful because it has dual structure and the pattern including a logo is printed between two layers. In the present invention that is manufactured by the method including the manufacturing procedure of the comb-handle core by injection molding; the forming procedure of the pattern on the surface of the comb-handle core; the diluting procedure after mixing a small amount of hardener and antifoam with Formica; the manufacturing procedure of the comb-handle that is hardened and dried after forming Formica layer to the outer face of the comb-handle core by fixing the comb-handle core to the inside of mold and by inputting the Formica dilute solution; the cutting processing procedure of the surface of the comb-handle; the glossy processing procedure of the surface of the comb-handle, the method for manufacturing of such a comb-handle that has an individuality and more high-grade beauty sense that is distinguished from the prior goods because even though the comb-handle is used for a long time, the pattern is not disappeared by forming the pattern between the comb-handle core and Formica layer and it has dual structure is provided.

### BACKGROUND OT THE INVENTION

1. Field of the Invention

The present invention relates to the method for manufacturing of comb-handle, more particularly to the method capable of manufacturing a comb-handle that its appearance is very beautiful because it has the dual structure and the pattern including a logo is printed between two layers.

2. Description of the Prior Art

Generally, the conventional comb-handle is manufactured by plastic, metal, etc. and the contents of the comb-handle are shown by the printed pattern including a logo and characters or stickers attached on its surface.

In such a comb-handle, not only the quality of its contents but also design of it is very important. Because a comb-handle, which is manufactured to evoke the beauty sense, can be distinguished from another goods, and can invoke desire to purchase from the women.

Therefore, recently when the comb-handle is manufactured, it is necessary to equip with various designs and manufacturing methods that can make obvious distinctions so as to be distinguished with the goods of competitive company.

### SUMMARY OF THE INVENTION

This invention is established to solve the problems stated above. It is an object of the present invention to provide with the method for manufacturing of such a comb-handle that its appearance is very beautiful because it has a dual structure and a pattern including a logo is printed between two layers.

To achieve the object of the present invention, there is provided with the manufacturing procedure of the comb-handle core by injection molding; the forming procedure of the pattern on the surface of the comb-handle core; the diluting procedure after mixing a small amount of hardener and antifoam with Formica; the manufacturing procedure of the comb-handle that is hardened and dried after forming Formica layer to the outer face of the comb-handle core by fixing the comb-handle core to the inside of mold and by inputting the Formica dilute solution; the milling processing procedure of the surface of the comb-handle; the glossy processing procedure of the surface of the comb-handle.

### BRIEF DESCRIPTION OF THE DRAWINGS

The above object and advantages of the present invention will become more apparent by describing in detail preferred embodiments thereof to the attached drawings in which;

FIG. 1 shows a perspective view of a comb-handle manufactured by the method according to the present invention.

FIGS. 2 and 3 show the sectional views of a comb-handle manufactured by the method according to the present invention.

FIG. 4 shows a process flow of the manufacturing method according to the present invention.

### DESCRIPTION OF THE PREFERRED EMBODIMENTS

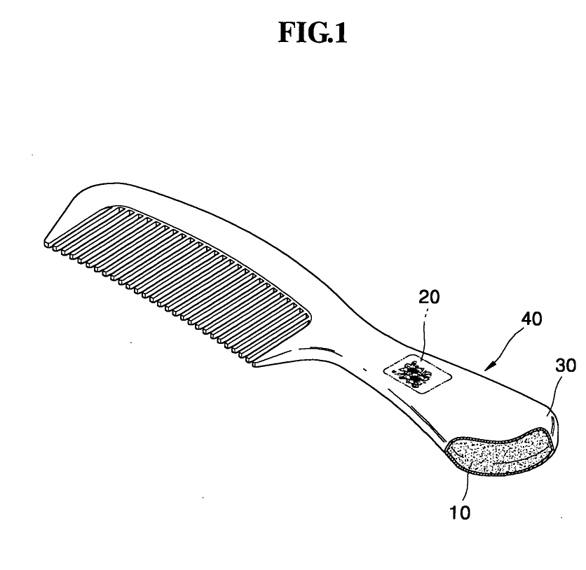

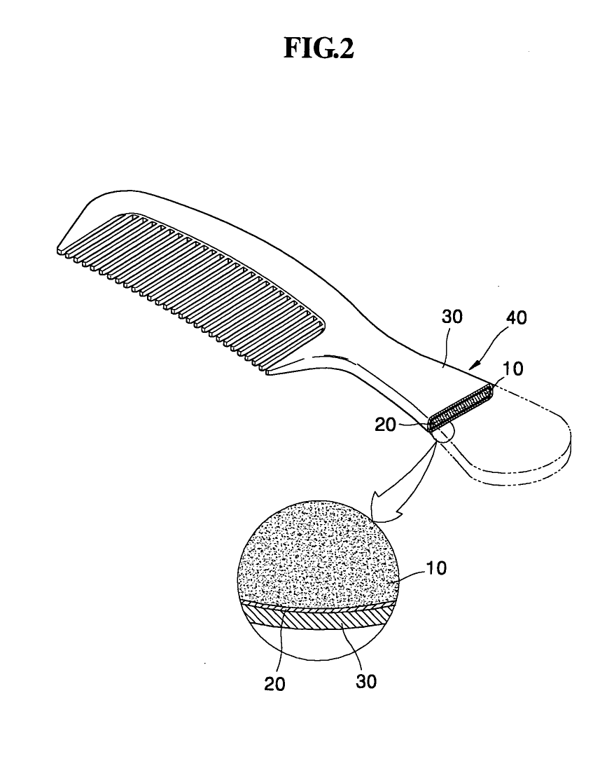

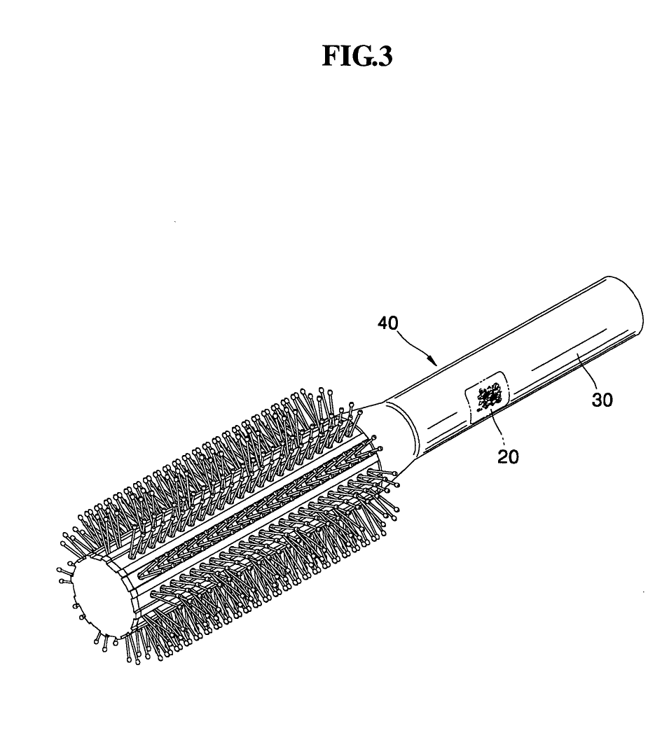

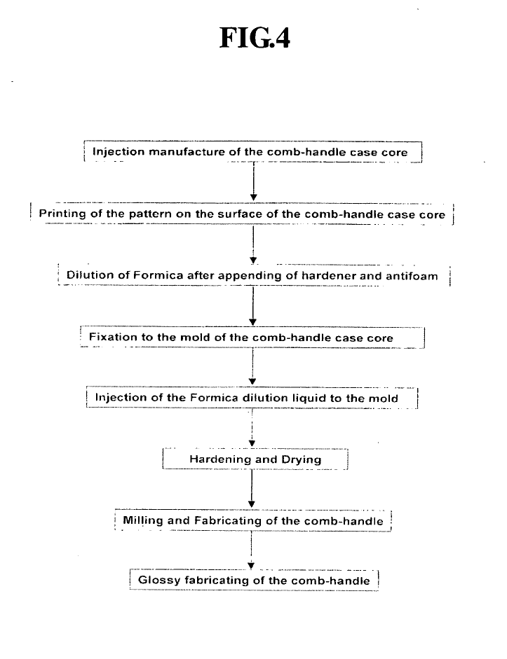

Referring now to the attached drawings, the embodiments according to this invention are described in detail FIG. 1 is a perspective view of a comb-handle manufactured by the method according to the present invention, FIGS. 2 and 3 are the sectional views of a comb-handle manufactured by the method according to the present invention, and FIG. 4 is a process flow showing the manufacturing method according to the present invention.

The comb-handle manufactured according to the present invention, as shown in the figures, is comprised of two-layered structure that the transparent Formica layer (30) is formed to the surface of the comb-handle core (10) as case type and the pattern (20) is printed between the comb-handle core (10) and the Formica layer (30). The manufacturing procedure will be described in detail as given below.

Firstly, a comb-handle core (10) as a handle (3) is manufactured by injecting of the plastic. Like this, it is desirable to manufacture a beautiful colored comb-handle core (10) by using the resin fusion liquid mixing resin with pigment at injecting of the comb-handle core (10).

If a body and a comb-handle core (10) as a handle are manufactured by injecting of plastic, the pattern (20) including a logo and characters is formed into its surface. Here, it can be possible to print the pattern (20) on the surface of the comb-handle core (10), to attach a sticker on which the pattern (20) is printed, or to form the pattern infixed to its surface at injection of the comb-handle core (10).

After that, a small amount of hardener and antifoam is appended at the dilution of Formica. Generally, Formica is called to the unsaturated polyester resin on the tempered plastic liquid and it is comprised of the chain structure by Styrene that is thermosetting plastics resin, has very strengthen adhesive force, and smells as a gas and Polyester, it has such a characteristics that it is hardened by the chemical reaction according to combining with the hardener. In the present invention, the antifoam and the hardener is appended into Formica for removing of foam that is generated at founding.

After making the dilute solution of Formica, the comb-handle (40) is manufactured by fixing said the comb-handle core (10) to the inner of the mold, forming Formica layer (30) to the surface of the comb-handle core (10) by hardening and drying it for about 10˜20 minutes after injecting of the Formica dilution liquid to the mold (not shown).

And, its surface is milled and fabricated by the lathe for smoothly fabricating of its surface because of rough and irregular of the surface of the molded Formica layer (30) after taking out the comb-handle (40) that has been hardened and dried in the mold.

Lastly, the surface of the comb-handle (40) is mercerized since the surface of the comb-handle (40) has milled and fabricated but here, it becomes to be done the finishing working for gloss by coating of the glossy liquid after fabricating the outer face of the comb-handle (40) that has milled and fabricated by the lathe by the sand paper that its particle is very fine.

In the comb-handle manufactured by the method as mentioned in above, its appearance is more beautiful and unique than the prior comb-handle that is manufactured by only metal and has the simple design that the simple pattern is printed on its surface because it is comprised of the dual structure equipping with the beautiful colored comb-handle core (10) to the inside and forming the glossy transparent Formica layer (30) and it has such a pattern that is formed between the comb-handle core (10) and Formica layer (30). Therefore, the present invention is more suitable to the modern who seeks to refreshment and individuality.

As stated in above, the present invention is characterized that even though the comb-handle is used for a long time, the pattern (20) is not disappeared because the pattern (20) is formed between the comb-handle core (10) and Formica layer (30), and also that provides with the method for manufacturing of such a comb-handle that has an individuality and more high-grade beauty sense that is distinguished from the prior goods because of its dual structure.

1. A method for manufacturing of comb-handle, comprising of the procedures of:
manufacturing procedure of the comb-handle core (10) by injection molding;
forming procedure of the pattern (20) on the surface of the comb-handle core (10);
diluting procedure after putting a small amount of hardener and antifoam into Formica;
manufacturing procedure of the comb-handle that is hardened and dried after forming Formica layer (30) to the outer face of the comb-handle core (10) by fixing the comb-handle core (10) to the inside of mold and then inputting the Formica dilute solution;
milling processing procedure of the surface of the comb-handle (40); and
glossy processing procedure of the surface of the comb-handle (40).
